(19) United States
(12) Patent Application Publication
(10) Pub. No.: US 2023/0178295 A1
(43) Pub. Date: Jun. 8, 2023

(54) REACTOR, CONVERTER, AND POWER CONVERSION DEVICE

(71) Applicant: Sumitomo Wiring Systems, Ltd., Yokkaichi-shi, Mie (JP)

(72) Inventor: Takahiro YAMASHITA, Yokkaichi-shi, Mie (JP)

(21) Appl. No.: 17/906,738

(22) PCT Filed: Mar. 4, 2021
(86) PCT No.: PCT/JP2021/008565

§ 371 Date: Sep. 19, 2022

(30) Foreign Application Priority Data
Mar. 23, 2020 (JP) 2020-051429

(51) Int. Cl. H01F 27/32; H01F 27/30; H01F 27/26; H01F 41/02

(52) U.S. Cl. CPC H01F 27/324; H01F 27/306; H01F 27/266; H01F 41/02

(57) ABSTRACT

A reactor including an assembly in which a coil, a magnetic core, and a holding member are combined, wherein the holding member includes: an outer surface facing a side on which the outer core portion of the magnetic core is disposed; a recessed core accommodating portion into which a part of the outer core portion is fitted; and a first holding portion facing a first outer circumferential surface of the outer core portion, the first holding portion includes: a plate-shaped piece extending from the outer surface to the first outer circumferential surface; and a pressing portion that presses the first outer circumferential surface, the plate shaped piece has a first surface flush with an inner wall surface of the core accommodating portion, and the pressing portion protrudes toward the first outer circumferential surface relative to the first surface.

### CROSS-REFERENCE TO RELATED APPLICATIONS

This application is the U.S. national stage of PCT/JP2021/008565 filed on Mar. 4, 2021, which claims priority of Japanese Patent Application No. JP 2020-051429 filed on Mar. 23, 2020, the contents of which are incorporated herein.

### TECHNICAL FIELD

The present disclosure relates to a reactor, a converter, and a power conversion device.

### BACKGROUND

A reactor is a component of a converter provided in a hybrid vehicle or the like. A reactor disclosed in JP 2019-153772A includes, for example, an assembly in which a coil, a magnetic core, and an interposing member are combined. The coil has a winding portion formed by winding a wire in a spiral shape. The magnetic core includes an inner core portion disposed inside the winding portion, and an outer core portion disposed outside the winding portion. The interposing member is a holding member that is disposed between an end surface of the winding portion and the outer core portion, and holds the coil and the magnetic core.

The holding member of the reactor disclosed in JP 2019-153772A is provided with a core accommodating portion that is a recess into which a part of the outer core portion is fitted. The holding member is provided with two flat-shaped support pieces. Each support piece is flush with the inner wall surface of the core accommodating portion. The two support pieces sandwich the upper surface and the lower surface of the outer circumferential surface of the outer core portion to position the outer core portion.

A slight clearance is provided between an inner wall surface of the core accommodating portion and an outer circumferential surface of the outer core portion. The clearance is provided to facilitate fitting of the outer core portion into the core accommodating portion. However, when the clearance between the inner wall surface of the core accommodating portion and the outer circumferential surface of the outer core portion becomes large due to dimensional tolerance, the outer core portion may fall and come loose from the holding member. When the outer core portion comes loose from the holding member, it takes time to fit the outer core portion again, and thus productivity of the reactor is reduced. Therefore, it is desired to improve the productivity of a reactor, by forming a reactor in which an outer core portion is firmly held with respect to a core accommodating portion.

An object of the present disclosure is to provide a reactor in which an outer core portion is firmly held by a holding member. Another object of the present disclosure is to provide a converter including a reactor that has excellent productivity, and a power conversion device.

### SUMMARY

A reactor according to the present disclosure includes an assembly in which a coil, a magnetic core, and a holding member are combined. The coil includes a winding portion formed by winding a wire, and the magnetic core includes an inner core portion disposed inside the winding portion and an outer core portion disposed outside the winding portion. The holding member is disposed between an end surface of the winding portion and the outer core portion. The holding member includes: an outer surface facing a side on which the outer core portion is disposed; a recessed core accommodating portion into which a part of the outer core portion is fitted; and a first holding portion facing a first outer circumferential surface of the outer core portion, the first holding portion includes: a plate-shaped piece extending from the outer surface to the first outer circumferential surface; and a pressing portion that presses the first outer circumferential surface, the plate-shaped piece has a first surface flush with an inner wall surface of the core accommodating portion, and the pressing portion protrudes toward the first outer circumferential surface relative to the first surface.

A converter according to the present disclosure includes the reactor according to the present disclosure.

A power conversion device according to the present disclosure includes the converter according to the present disclosure.

Effects of the Present Disclosure

In the reactor according to the present disclosure, an outer core portion can be firmly held by a holding member using a pressing portion included in the holding member.

Furthermore, the converter and the power conversion device according to the present disclosure have excellent productivity.

### BRIEF DESCRIPTION OF DRAWINGS

FIG. 1 is a schematic perspective view of a reactor according to a first embodiment.

FIG. 2 is a schematic perspective view of the reactor viewed from an angle different from that of FIG. 1.

FIG. 3 is a schematic perspective view of a holding member included in the reactor according to the first embodiment when the holding member is viewed obliquely from above.

FIG. 4 is a schematic perspective view of a holding member included in the reactor according to the first embodiment when the holding member is viewed obliquely from below.

FIG. 5 is a schematic perspective view of the holding member as viewed from the side opposite that shown in FIG. 4.

FIG. 6 is a cross-sectional view taken along line VI-VI of FIG. 2.

FIG. 7 is a schematic view illustrating an example of a method for manufacturing the reactor according to the first embodiment.

FIG. 8 is a schematic perspective view of a holding member included in the reactor according to a second embodiment when the holding member is viewed obliquely from above.

FIG. 9 is a schematic perspective view of the holding member included in the reactor according to the second embodiment when the holding member is viewed obliquely from below.

FIG. 10 is a configuration diagram schematically showing a power supply system of a hybrid vehicle according to a third embodiment.

FIG. 11 is a circuit diagram schematically illustrating an example of a power conversion device including a converter according to the third embodiment.

### DETAILED DESCRIPTION OF PREFERRED EMBODIMENTS

First, aspects of the present disclosure will be listed and described.

First Aspect

A reactor according to a first aspect includes an assembly in which a coil, a magnetic core, and a holding member are combined, wherein the coil includes a winding portion formed by winding a wire, the magnetic core includes an inner core portion disposed inside the winding portion and an outer core portion disposed outside the winding portion. The holding member is disposed between an end surface of the winding portion and the outer core portion. The holding member includes: an outer surface facing a side on which the outer core portion is disposed; a recessed core accommodating portion into which a part of the outer core portion is fitted; and a first holding portion facing a first outer circumferential surface of the outer core portion, the first holding portion includes: a plate-shaped piece extending from the outer surface to the first outer circumferential surface; and a pressing portion that presses the first outer circumferential surface, the plate-shaped piece has a first surface flush with an inner wall surface of the core accommodating portion, and the pressing portion protrudes toward the first outer circumferential surface relative to the first surface.

The first outer circumferential surface is one of the plurality of outer circumferential surfaces. The plurality of outer circumferential surfaces are surfaces excluding an inner end surface and an outer end surface in the outer core portion. The inner end surface is a surface of the outer core portion facing the end surface of the inner core portion. The outer end surface is a surface facing a direction away from the end surface of the inner core portion. The first outer circumferential surface is, for example, an upper surface, a lower surface, or a side surface of the outer core portion.

In the reactor according to the present disclosure, the outer core portion is firmly held by the holding member.

In the reactor according to the present disclosure, the pressing portion provided on the holding member protrudes toward the first outer circumferential surface of the outer core portion relative to the first surface of the plate-shaped piece. Because the first surface is flush with the inner wall surface of the core accommodating portion, the pressing portion of the holding member protrudes toward the first outer circumferential surface of the outer core portion relative to the inner wall surface of the core accommodating portion. The first outer circumferential surface of the outer core portion is pressed by the pressing portion, and the outer core portion is pressed against a portion of the inner wall surface of the core accommodating portion on a side opposite to the pressing portion. Therefore, even if the clearance between the inner wall surface of the core accommodating portion and the outer circumferential surface of the outer core portion becomes large due to a dimensional tolerance between the holding member and the outer core portion, the outer core portion is firmly held by the holding member using the pressing portion. As a result, detachment of the outer core portion from the holding member is suppressed. Therefore, work involved in fitting the outer core portion again into the core accommodating portion of the holding member is reduced, and thus productivity of the reactor is improved.

Second Aspect

In a second aspect of the reactor according to the embodiment, the pressing portion is a protrusion provided on the first surface, and the protrusion extends in a depth direction of the core accommodating portion.

The protrusion provided on the first surface of the plate-shaped piece can firmly press the first outer circumferential surface of the outer core portion. In addition, when the protrusion presses the first outer circumferential surface of the outer core portion, the plate-shaped piece bends, and thus an excessive pressing force is unlikely to act on the first outer circumferential surface of the outer core portion.

Third Aspect

In a third aspect of the reactor according to the second aspect, a protrusion amount of the protrusion from the first surface increases toward a bottom surface of the core accommodating portion.

In other words, in the third aspect, the protrusion amount of the protrusion decreases from the bottom surface of the core accommodating portion toward an opening portion. In a configuration in which the protrusion amount of the protrusion decreases from the bottom surface of the core accommodating portion toward the opening portion, the outer core portion can be easily fitted into the core accommodating portion. Furthermore, in a configuration in which the protrusion amount of the protrusion increases toward the bottom surface of the core accommodating portion, the force with which the protrusion presses the outer core portion increases as the outer core portion is pushed toward the bottom portion of the core storage portion. Therefore, the outer core portion fitted into the back of the core accommodating portion is less likely to come loose from the core accommodating portion.

Fourth Aspect

In a fourth aspect of the reactor according to the second or third aspect, a cross-sectional shape orthogonal to an extending direction of the protrusion is a tapered shape that narrows in a protruding direction of the protrusion.

Because the protruding end of the protrusion is narrowed, a contact area between the protrusion and the outer core portion is reduced when the outer core portion is fitted into the core accommodating portion. Therefore, the outer core portion can be easily fitted into the core accommodating portion.

Fifth Aspect

In a fifth aspect of the reactor according to the first aspect, the pressing portion is a cantilever spring.

The pressing portion formed by the cantilever spring bends in a direction away from the first outer circumferential surface of the outer core portion when the outer core portion is fitted into the core accommodating portion. Accordingly, the cantilever spring is unlikely to damage the first outer circumferential surface of the outer core portion. Furthermore, the cantilever spring presses the first outer circumferential surface of the outer core portion using its elasticity, and firmly holds the outer core portion in the core accommodating portion.

Sixth Aspect

In a sixth aspect of the reactor according to the fifth aspect, the cantilever spring is provided on a side of the plate-shaped piece.

The cantilever spring provided on the side of the plate-shaped piece is independent from the plate-shaped piece. The cantilever spring independent from the plate-shaped piece is easier to form than the cantilever spring provided on the first surface of the plate-shaped piece.

Seventh Aspect

In a seventh aspect of the reactor according to the fifth or the sixth aspect, the base end of the cantilever spring is connected to the inner wall surface of the core accommodating portion.

The inner wall surface of the core accommodating portion has higher rigidity and is less likely to deform than the plate-shaped piece. Accordingly, if the base end of the cantilever spring is connected to the inner wall surface of the core accommodating portion, the pressing force applied from the cantilever spring can be appropriately maintained. In contrast, if the base end of the cantilever spring is connected to the plate-shaped piece, there is a possibility that the plate-shaped piece will also bend in accordance with the bending of the cantilever spring. As a result, there is a possibility that the pressing force applied from the cantilever spring will not be stabilized.

Eighth Aspect

In an eighth aspect of the reactor according to the embodiment, the holding member includes a through hole penetrating the inner core portion, and in a front view of the holding member as seen from the outer surface side, the pressing portion is provided at a position overlapping the through hole.

The holding member is commonly resin-molded. In this case, if the pressing portion is provided at a position overlapping the through hole, the releasability of the mold corresponding to the pressing portion is improved.

Ninth Aspect

In a ninth aspect of the reactor according to the embodiment, the holding member includes a second holding portion extending from the outer surface in an axial direction of the winding portion, and the second holding portion is provided at a position facing the first holding portion with the core accommodating portion interposed therebetween.

In the reactor including the second holding portion in addition to the first holding portion, the outer core portion is sandwiched between the first holding portion and the second holding portion at a position outside the core accommodating portion. With this configuration, the outer core portion is less likely to come loose from the core accommodating portion of the holding member.

Tenth Aspect

In a tenth aspect of the reactor according to the embodiment, the reactor further includes an outer mold portion that covers at least a part of an outer circumference of the assembly.

The outer mold portion firmly integrates the components of the assembly.

In particular, if the outer core portion is integrated with the holding member by the outer mold portion, the components of the assembly are less likely to become disassembled. In addition, the outer core portion is protected from the external environment by the outer mold portion.

Eleventh Aspect

In an eleventh aspect of a converter according to the embodiment, the converter includes the reactor according to any one of the first to the tenth aspects.

The converter according to the present disclosure includes the reactor according to the present disclosure that has excellent productivity. Therefore, the converter according to the present disclosure has excellent productivity.

Twelfth Aspect

A power conversion device according to the embodiment includes the converter according to the eleventh aspect.

The power conversion device according to the present disclosure includes the converter according to the present disclosure, which has excellent productivity. Therefore, the power conversion device according to the present disclosure has excellent productivity.

Hereinafter, embodiments of a reactor according to the present disclosure will be described with reference to the drawings. The same reference numerals in the drawings denote the same components. The present disclosure is not limited to the configurations shown in the embodiments, but is defined by the scope of claims, and is intended to include meanings equivalent to the scope of claims and all modifications within the scope.

### First Embodiment

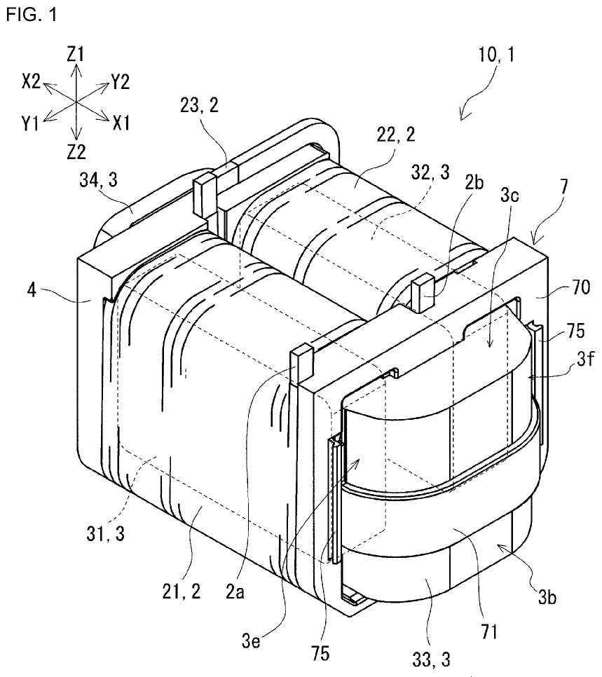

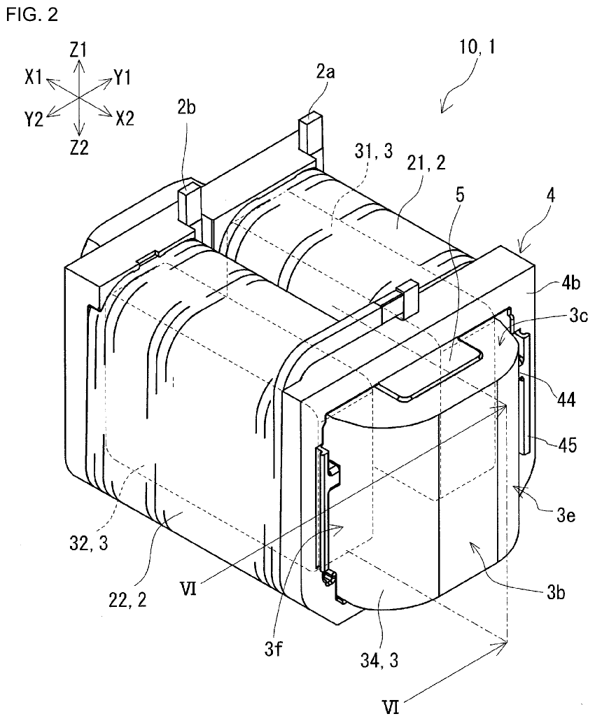

In the first embodiment, the configuration of a reactor 1 will be described based on FIGS. 1 to 7. The reactor 1 shown in FIGS. 1 and 2 includes an assembly 10 in which a coil 2, a magnetic core 3, and a holding member 4 are combined. One of the features of the reactor 1 is the configuration of the holding member 4. Hereinafter, configurations included in the reactor 1 will be described in detail.

Coil

The coil 2 according to the present example includes a winding portion 21 and a winding portion 22 that are arranged in parallel with each other, and a coupling portion 23 that couples the winding portions 21 and 22 to each other. Each of the winding portions 21 and 22 is formed by winding a single winding wire. A known winding wire can be used as the winding wire. The winding wire in the present example is a coated rectangular wire. The conductor wire of the coated rectangular wire is constituted by a rectangular wire made of copper. The insulating coating of the coated rectangular wire is made of enamel. Each of the winding portions 21 and 22 is formed of an edgewise coil obtained by edgewise winding a coated rectangular wire.

The winding portions 21 and 22 have a rectangular tubular shape. The rectangle includes a square. That is to say, the end surfaces of the winding portions 21 and 22 have a rectangular frame shape. Because the shapes of the winding portions 21 and 22 are rectangular tubular shapes, it is easy to increase the contact areas between the winding portions 21 and 22 and an installation target as compared with a case where the winding portions are cylindrical shapes having the same cross-sectional area. Accordingly, the reactor 1 can easily dissipate heat to the installation target via the winding portions 21 and 22. In addition, the winding portions 21 and 22 can be easily and stably installed on the installation target. Here, the corners of the winding portions 21 and 22 are preferably rounded.

An end portion 2a and an end portion 2b of the coil 2 are extended to the outer circumferential side of the winding portions 21 and 22, respectively. At each of the end portion 2a and the end portion 2b, the insulating coating is stripped and the conductor wire is exposed. Terminal members (not shown) are connected to the respective exposed conductor wires. An external device is connected to the coil 2 through the terminal members. Illustration of the external device is omitted. Examples of the external device include a power supply that supplies power to the coil 2.

Here, directions in the reactor 1 are defined with reference to the coil 2. First, a direction along the axial direction of the winding portions 21 and 22 of the coil 2 is defined as an X-axis direction. A direction orthogonal to the X-axis direction and along the parallel direction of the winding portions 21 and 22 is defined as a Y-axis direction. Then, a direction intersecting both the X-axis direction and the Y-axis direction is referred to as a Z-axis direction. Furthermore, the following directions are defined.

X1 direction: a direction toward the end portions 2a and 2b in the X-axis direction.

X2 direction: a direction toward the coupling portion 23 in the X-axis direction

Y1 direction: a direction toward the winding portion 21 in the Y-axis direction.

Y2 direction: a direction toward the winding portion 22 in the Y-axis direction.

Z1 direction: a direction toward the side where the coupling portion 23 is disposed in the Z-axis direction.

Z2 direction: a direction opposite to the Z1 direction in the Z-axis direction.

Magnetic Core

The magnetic core 3 includes an inner core portion 31, an inner core portion 32, an outer core portion 33, and an outer core portion 34. The inner core portion 31 is disposed inside the winding portion 21. The inner core portion 32 is disposed inside the winding portion 22. The outer core portion 33 connects the end portion of the inner core portion 31 and the end portion of the inner core portion 32 in the X1 direction. The outer core portion 34 connects the end portion of the inner core portion 31 and the end portion of the inner core portion 32 in the X2 direction. A closed magnetic path is formed by annularly connecting the core portions 31, 32, 33, and 34.

Inner Core Portions

The inner core portions 31 and 32 are portions extending along the axial direction of the winding portions 21 and 22 of the coil 2, that is to say, along the X-axis direction. In the present example, two end portions of portions of the magnetic core 3 extending along the axial direction of the winding portions 21 and 22 respectively protrude from the end surfaces of the winding portions 21 and 22. These protruding portions are also parts of the inner core portions 31 and 32.

The shape of the inner core portions 31 and 32 is not particularly limited as long as the shape conforms to the inner shape of the winding portions 21 and 22. Each of the inner core portions 31 and 32 according to the present example has a substantially rectangular parallelepiped shape. The inner core portions 31 and 32 may have a configuration in which a plurality of split cores and gap plates are coupled to each other, or may also be formed as one member.

Outer Core Portions

The outer core portions 33 and 34 are portions of the magnetic core 3 that are disposed outside the winding portions 21 and 22. The shape of the outer core portions 33 and 34 is not particularly limited as long as the outer core portions 33 and 34 have a shape with which the end portions of the pair of inner core portions 31 and 32 can be connected. The outer core portions 33 and 34 according to the present example are columnar bodies whose upper surfaces and lower surfaces are substantially dome-shaped.

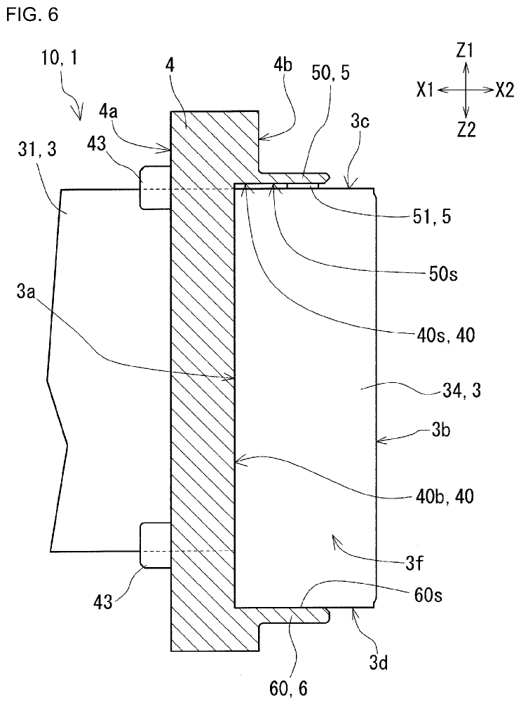

The outer core portions 33 and 34 each include an inner end surface 3a (FIG. 6), an outer end surface 3b, and a first outer circumferential surface 3c. The inner end surfaces 3a (FIG. 6) are surfaces facing end surfaces of the inner core portions 31 and 32 in the X-axis direction. The outer end surfaces 3b are surfaces facing a direction away from the end surfaces of the inner core portions 31 and 32 in the X-axis direction. The first outer circumferential surfaces 3c of the present example are upper surfaces facing the Z1 direction. The outer core portions 33 and 34 of the present example each include, in addition to the first outer circumferential surface 3c, a second outer circumferential surface 3d (FIG. 6), which is a lower surface facing the Z2 direction, a third outer circumferential surface 3e, which is a side surface facing the Y1 direction, a fourth outer circumferential surface 3f, which is a side surface facing the Y2 direction, and the like. Unlike the present example, the lower surfaces or the side surfaces of the outer core portions 33 and 34 may be defined as the first outer circumferential surfaces. When the lower surfaces of the outer core portions 33 and 34 are defined as the first outer circumferential surfaces, for example, first holding portions 5 (FIG. 6) described later are provided at positions facing the lower surfaces of the outer core portions 33 and 34.

As shown in FIG. 1, at least a part of the outer core portion 33 of the present example is covered by a core mold portion 7. The configuration of the core mold portion 7 will be described later.

Magnetic Properties, Material, and the Like

Each of the core portions 31, 32, 33, and 34 of the magnetic core 3 is preferably a powder compact obtained by pressure-molding raw material powder containing soft magnetic powder or a compact of a composite material of soft magnetic powder and resin. All of the core portions 31, 32, 33, and 34 may be powder compacts, or all of the core portions 31, 32, 33, and 34 may be compacts of a composite material. Alternatively, some of the core portions 31, 32, 33, and 34 may be powder compacts, and the rest may be compacts of a composite material. A magnetic core 3 in which some of its components are powder compacts and the rest are a compact of a composite material is less likely to be magnetically saturated.

The soft magnetic powder of the powder compact is an aggregate of soft magnetic particles composed of an iron group metal such as iron, or an iron alloy such as an Fe (iron)-Si (silicon) alloy or an Fe—Ni (nickel) alloy. An insulating coating composed of phosphate or the like may be formed on the surface of the soft magnetic particle. The material powder may contain a lubricant and the like.

The molded body of the composite material can be produced by filling a mold with a mixture of soft magnetic powder and an unsolidified resin, and solidifying the resin. As soft magnetic powder of the composite material, the same soft magnet powder that is used for the powder compact can be used. On the other hand, examples of a resin contained in the composite material include a thermosetting resin, a thermoplastic resin, a normal temperature hardening resin, and a low temperature hardening resin. Examples of the thermosetting resin include an unsaturated polyester resin, an epoxy resin, a urethane resin, and a silicone resin. Examples of the thermoplastic resin include a polyphenylene sulfide (PPS) resin, a polytetrafluoroethylene (PTFE) resin, a liquid crystal polymer (LCP), a polyamide (PA) resin such as nylon 6 or nylon 66, a polybutylene terephthalate (PBT) resin, and an acrylonitrile butadiene styrene (ABS) resin. Other examples include a BMC (Bulk Molding Compound) in which calcium carbonate or glass fiber is mixed with unsaturated polyester, millable silicone rubber, and millable urethane rubber.

If the above-described composite material contains a soft non-magnetic and non-metal powder (filler) such as alumina or silica in addition to the magnetic powder and the resin, it is possible to further improve the heat dissipation performance. The content of the non-magnetic and non-metal powder may be 0.2% by mass or more and 20% by mass or less, 0.3% by mass or more and 15% by mass or less, or 0.5% by mass or more and 10% by mass or less.

The content of the soft magnetic powder in the composite material may be 30% by volume or more and 80% by volume or less. From the viewpoint of improving saturation magnetic flux density and heat dissipation, the content of the magnetic powder can be further set to 50% by volume or more, 60% by volume or more, or 70% by volume or more. From the viewpoint of improving the flowability in a manufacturing process, it is preferable that the content of the soft magnetic powder is 75% by volume or less. In the molded body of the composite material, when the filling rate of the soft magnetic powder is adjusted to be low, the relative magnetic permeability tends to be low. The relative magnetic permeability of the molded body of the composite material is, for example, 5 or more and 50 or less. The relative magnetic permeability of the molded body of the composite material may be 10 or more and 45 or less, 15 or more and 40 or less, or 20 or more and 35 or less.

In the powder compact, the content of the soft magnetic powder is more easy to increase than in the compact of the composite material. The content of the soft magnetic powder in the powder compact is more than 80% by volume, or 85% by volume or more, for example. The core piece formed of the powder compact is likely to have high saturation magnetic flux density and high relative magnetic permeability. The relative magnetic permeability of the powder compact is, for example, 50 or more and 500 or less. The relative magnetic permeability of the powder compact may be 80 or more, 100 or more, 150 or more, or 180 or more.

Holding Member

The holding member 4 shown in FIG. 2 is a member that is interposed between the end surfaces in the X2 direction of the winding portions 21 and 22 of the coil 2 and the inner end surface 3a (FIG. 6) of the outer core portion 34 of the magnetic core 3, and holds the coil 2 and the magnetic core 3. The holding member 4 is representatively made of an insulating material and functions as an insulating member between the coil 2 and the magnetic core 3. In addition, the holding member 4 also functions as a positioning member for positioning the inner core portions 31 and 32 and the outer core portions 33 and 34 with respect to the winding portions 21 and 22.

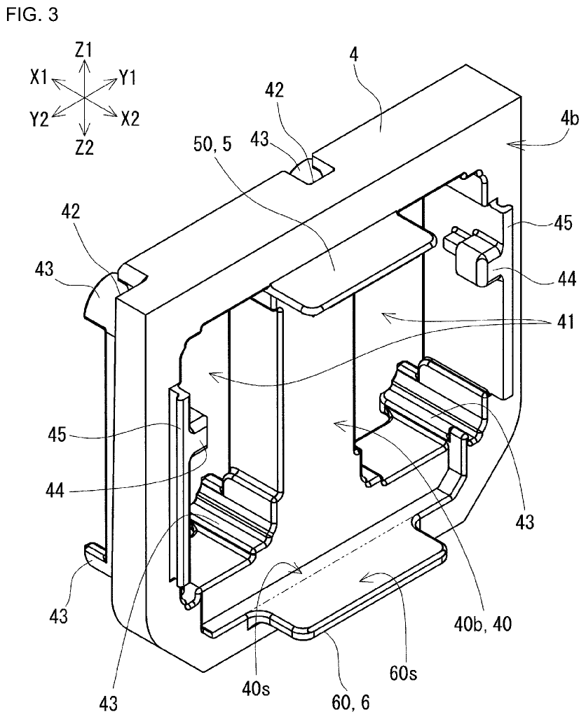

As shown in FIGS. 3 to 5, the holding member 4 includes a core accommodating portion 40, through holes 41, coil accommodating portions 42, core supporting portions 43, protruding portions 44, retaining portions 45, a first holding portion 5, and a second holding portion 6.

Core Accommodating Portion

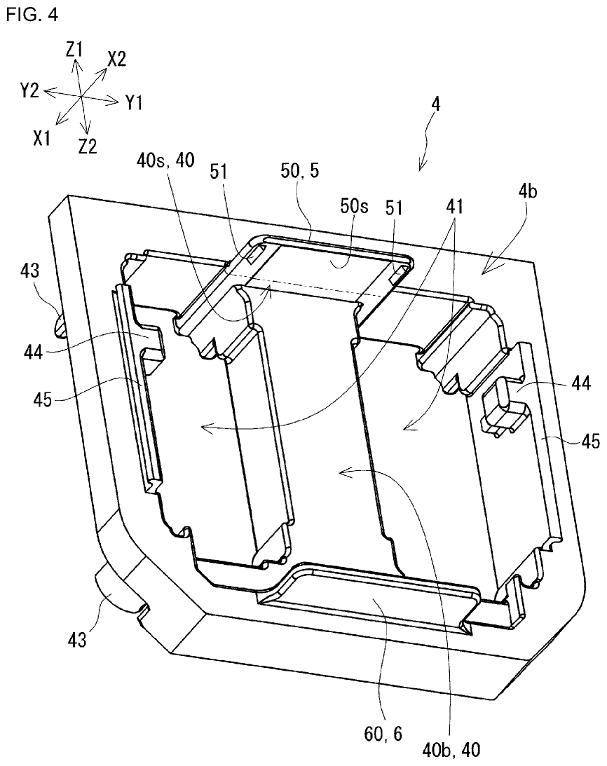

As shown in FIGS. 3 and 4, the core accommodating portion 40 is provided on an outer surface 4b of the holding member 4 that faces the outer core portion 34 (FIG. 6). The core accommodating portion 40 is formed by recessing the outer surface 4b of the holding member 4. Apart of the outer core portion 34 is fitted into the core accommodating portion 40. The part of the outer core portion 34 is the inner end surface 3a and the vicinity thereof (FIG. 6). The core accommodating portion 40 is provided with a bottom surface 40b facing the X2 direction and an inner wall surface 40s extending from the bottom surface 40b to an opening portion of the core accommodating portion 40. The inner end surface 3a of the outer core portion 34 comes close to or into contact with the bottom surface 40b (FIG. 6).

The core accommodating portion 40 has a shape substantially matching a contour line of the outer core portion 34 in a front view as seen from a side of an outer end surface 3b of the outer core portion 34. Note that a part of an upper edge portion and a part of side edge portions of the core accommodating portion 40 are expanded outward from the contour line. Because the portions other than the outwardly expanded portions correspond to the contour line of the outer core portion 34, movement of the outer core portion 34 fitted into the core accommodating portion 40 is restricted in the Y-axis direction and the Z-axis direction.

Through Holes

The through holes 41 are holes penetrating the holding member 4 in the thickness direction thereof. The through holes 41 penetrate the bottom surface 40b of the core accommodating portion 40. An end portion of the inner core portion 31 (FIGS. 1 and 2) is disposed in one through hole 41, and an end portion of the inner core portion 32 (FIGS. 1 and 2) is disposed in the other through hole 41.

Coil Accommodating Portions

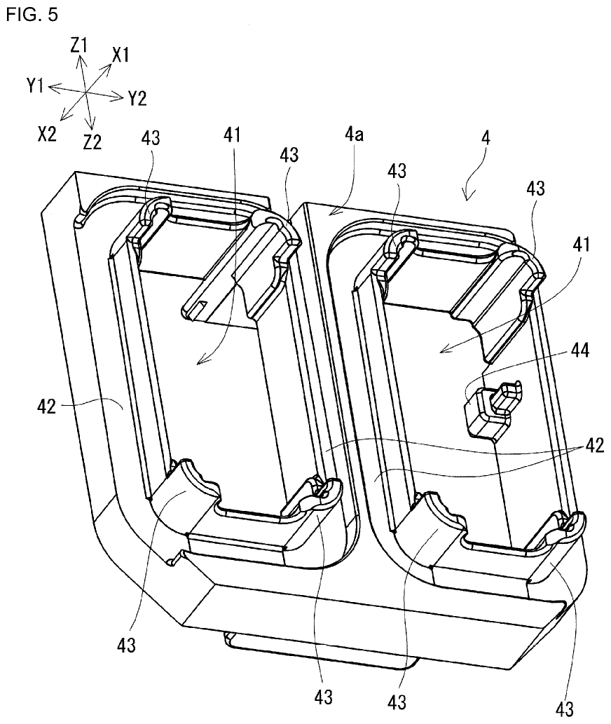

As shown in FIG. 5, the coil accommodating portions 42 are provided on an inner surface 4a that faces the inner core portions 31 and 32 of the holding member 4 (FIGS. 1 and 2). The coil accommodating portions 42 are recesses formed so as to surround the respective through holes 41. The shape of the recesses follows the shape of end surfaces of the winding portions 21 and 22 (FIGS. 1 and 2). Accordingly, the end surfaces of the winding portions 21 and 22 are brought into surface contact with the holding member 4 at the positions of the respective coil accommodating portions 42.

Core Supporting Portions

As shown in FIGS. 3 to 5, the core supporting portions 43 protrude inward in the radial direction of the through holes 41 from the inner circumferential surfaces of the through holes 41, and support the corner portions of the inner core portions 31 and 32. The core supporting portions 43 according to the present example are arc-shaped pieces that follow the rounded parts of the corner portions of the outer circumferential surfaces of the inner core portions 31 and 32. The core supporting portions 43 are provided at four corners of each through hole 41. The four core supporting portions 43 respectively support the four corners of the inner circumferential surfaces of the winding portions 21 and 22 (FIGS. 1 and 2). As a result, the relative positions of the winding portions 21 and 22 and the inner core portions 31 and 32 are determined by the core supporting portions 43. A clearance corresponding to the thickness of the core supporting portion 43 is formed between the inner circumferential surfaces of the winding portions 21 and 22 and the outer circumferential surfaces of the inner core portions 31 and 32.

An upper edge portion, a lower edge portion, and both side edge portions of each through hole 41 excluding the core support portions 43 are expanded outward from the contour lines of the end surfaces of the inner core portions 31 and 32. Therefore, the shape of the through hole 41 viewed from the axial direction of the through hole 41 is a substantially “+” shape. When the inner core portions 31 and 32 are fitted into the respective through holes 41, resin filling holes penetrating in the thickness direction of the holding member 4 are formed between the outer circumferential surfaces of the inner core portions 31 and 32 fitted into the through holes 41 and the inner circumferential surfaces of the through holes 41. The resin filling holes are in communication with clearances between the winding portions 21 and 22 and the inner core portions 31 and 32 inside the winding portions 21 and 22.

Protruding Portions

The protruding portions 44 each protrude inward from the inner wall surface 40s of the core accommodating portion 40 and determine the position of the outer core portion 34 in the Y-axis direction. Each of the protruding portions 44 according to the present example extend to the inner circumferential surface of the corresponding through hole 41 and the inner circumferential surface of the corresponding retaining portion 45. The protruding portions 44 may be omitted.

Retaining Portions

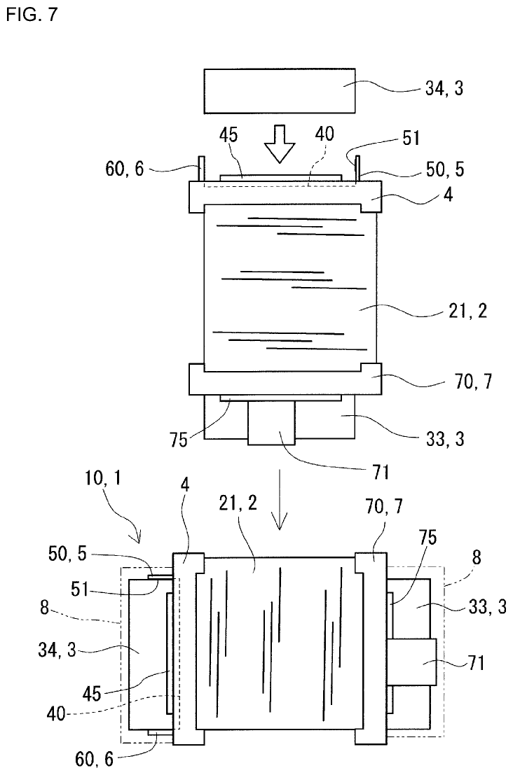

As shown in FIGS. 3 and 4, the retaining portions 45 are protrusions provided along side edges of the core accommodating portion 40, on the outer surface 4b. A distal end in the X2 direction of the retaining portion 45 on the left side in the drawings is bent toward the Y2 direction from the core accommodating portion 40. Also, a distal end in the X2 direction of the retaining portion 45 on the right side in the drawings is bent toward the Y1 direction from the core accommodating portion 40. That is to say, the cross section orthogonal to the Z-axis direction of the retaining portions 45 is substantially L-shaped. The retaining portions 45 prevent an outer mold portion 8 (FIG. 7) covering the outer circumference of the outer core portion 34 from being separated from the holding member 4. The outer mold portion 8 will be described later with reference to FIG. 7.

First Holding Portion

As shown in FIG. 4, the first holding portion 5 includes a plate-shaped piece 50 and pressing portions 51. The plate-shaped piece 50 according to the present example is provided on the outer surface 4b of the holding member 4, and extends in the X2 direction where the outer core portion 34 is disposed. The plate-shaped piece 50 is provided along the upper edge of the opening of the core accommodating portion 40. A first surface 50s facing the Z2 direction of the plate-shaped piece 50 is flush with the inner wall surface 40s of the core accommodating portion 40. In FIG. 4, the boundary between the first surface 50s and the inner wall surface 40s is indicated by a two-dot chain line. As shown in FIG. 6, the first surface 50s extends along the first outer circumferential surface 3c of the outer core portion 34 and holds the first outer circumferential surface 3c of the outer core portion 34.

The pressing portions 51 according to the present example are protrusions provided on the first surface 50s of the plate-shaped piece 50, and extend in the depth direction of the core accommodating portion 40, that is to say, in the X-axis direction. Accordingly, the pressing portions 51 protrude toward the first outer circumferential surface 3c of the outer core portion 34 relative to the first surface 50s. As shown in FIG. 6, because the first surface 50s is flush with the inner wall surface 40s of the core accommodating portion 40, the pressing portions 51 protrude toward the first outer circumferential surface 3c relative to the inner wall surface 40s. Therefore, even if the clearance between the inner wall surface 40s of the core accommodating portion 40 and the first outer circumferential surface 3c of the outer core portion 34 becomes large due to a dimensional tolerance between the holding member 4 and the outer core portion 34, the outer core portion 34 is firmly held by the holding member 4 using the pressing portions 51. In addition, because the pressing portions 51 are provided on the plate-shaped piece 50, the plate-shaped piece 50 bends when the pressing portions 51 press the first outer circumferential surface 3c of the outer core portion 34. As a result, an excessive pressing force is kept from acting on the first outer circumferential surface 3c of the outer core portion 34. Therefore, the first outer circumferential surface 3c is less likely to be damaged by the pressing portions 51.

As shown in FIG. 4, the number of pressing portions 51 in the present example is two. The two pressing portions 51 are provided at positions overlapping the respective through holes 41 in a front view of the holding member 4 as seen from the side of the outer surface 4b. When the pressing portions 51 are located at positions corresponding to the through holes 41, the mold corresponding to the pressing portions 51 can be pulled out to the through hole 41 side. As a result, the demolding properties of the mold are improved easier. Note that the number of pressing portions 51 may be one or three or more.

The cross-sectional shape of the pressing portions 51 orthogonal to the extending direction is preferably a tapered shape that becomes narrower toward the protruding direction of the pressing portions 51. The cross-sectional shape of the pressing portions 51 according to the present example is triangular (FIG. 4). Because the protruding ends of the pressing portions 51 are narrowed, contact areas between the pressing portions 51 and the outer core portion 34 are reduced when the outer core portion 34 is fitted into the core accommodating portion 40. Therefore, the outer core portion 34 can be easily fitted into the core accommodating portion 40. In addition, when the protruding ends of the pressing portions 51 have a tapered shape, the shape of the pressing portions 51 is likely to deform, and there is also an effect that the first outer circumferential surface 3c is less likely to be damaged by the pressing portions 51. Unlike the present example, the tapered cross-sectional shape of the pressing portions 51 may be a trapezoid or a semicircle. Needless to say, the cross-sectional shape of the pressing portions 51 is not limited to a tapered shape, and may also be, for example, a rectangular shape.

The protrusion amount of each pressing portion 51 from the first surface 50s may be uniform in the longitudinal direction of the pressing portion 51, but preferably increases toward the bottom surface 40b of the core accommodating portion 40. In other words, it is preferable that the protrusion amount of the pressing portions 51 from the first surface 50s decreases from the bottom surface 40b of the core accommodating portion 40 toward the opening portion. In a configuration in which the protrusion amount of the pressing portions 51 decreases toward the opening portion of the core accommodating portion 40, the outer core portion 34 can be easily fitted into the core accommodating portion 40. Furthermore, in a configuration in which the protrusion amount of the pressing portions 51 increases toward the bottom surface 40b of the core accommodating portion 40, the force with which the pressing portion 51 presses the outer core portion 34 increases as the outer core portion 34 is pushed toward the bottom surface 40b of the core accommodating portion 40. Therefore, the outer core portion 34 fitted deep into the core accommodating portion 40 is less likely to come loose from the core accommodating portion 40.

As another form of the pressing portions 51, the pressing portions 51 may also be provided on the inner wall surface 40s of the core accommodating portion 40. In this case as well, the pressing portions 51 protrude toward the first outer circumferential surface 3c of the outer core portion 34 relative to the first surface 50s. Each of the pressing portions 51 may be provided spanning from the first surface 50s to the inner wall surface 40s.

Second Holding Portion

As shown in FIGS. 3, 4, and 6, the second holding portion 6 includes a plate-shaped piece 60. The plate-shaped piece 60 according to the present example is provided on the outer surface 4b of the holding member 4, and extends in the X2 direction where the outer core portion 34 is disposed. The plate-shaped piece 60 is provided along the lower edge of the opening portion of the core accommodating portion 40. As shown in FIG. 3, a second surface 60s, which is an upper surface of the plate-shaped piece 60, is flush with the inner wall surface 40s of the core accommodating portion 40. In FIG. 3, the boundary between the second surface 60s and the inner wall surface 40s is indicated by a two-dot chain line. As shown in FIG. 6, the second surface 60s extends along the second outer circumferential surface 3d, which is the lower surface of the outer core portion 34, and holds the second outer circumferential surface 3d.

Because the outer core portion 34 is sandwiched between the first holding portion 5 and the second holding portion 6, the outer core portion 34 is easily prevented from coming loose from the holding member 4.

Unlike the present example, the second holding portion 6 may also include a pressing portion similarly to the first holding portion 5. In this case, the pressing portion of the second holding portion 6 is configured to protrude toward the second outer circumferential surface 3d of the outer core portion 34 relative to the second surface 60s of the plate-shaped piece 60.

Material

The holding member 4 can be made of a thermoplastic resin such as a PPS resin, a PTFE resin, an LCP, a PA resin, a PBT resin, or an ABS resin. Alternatively, the holding member 4 can be made of, for example, a thermosetting resin such as an unsaturated polyester resin, an epoxy resin, a urethane resin, or a silicone resin. For improving the heat dissipation of the holding member 4, a ceramic filler may be contained in these resins. As a ceramic filler, for example, nonmagnetic powder such as alumina or silica can be used.

Core Mold Portion

As shown in FIG. 1, the core mold portion 7 covers at least a part of the outer circumference of the outer core portion 33. In the present example, the core mold portion 7 includes an interposing portion 70, a holding portion 71, and retaining portions 75. The interposing portion 70 has a function similar to that of the holding member 4. That is to say, the core mold portion 7 is interposed between the end surfaces of the winding portions 21 and 22 and the inner end surface 3a of the outer core portion 33, and has a portion that holds the coil 2 and the magnetic core 3. Portions corresponding to the coil accommodating portion 42 and the core supporting portion 43 in the holding member 4 are provided on an end surface of the interposing portion 70 in the X1 direction.

The holding portion 71 of the core mold portion 7 is a band-shaped member disposed on the outer circumferential surface 3e, the outer end surface 3b, and the outer circumferential surface 3f on the X1 direction side of the outer core portion 33. The width of the holding portion 71 in the Z-axis direction is smaller than the height of the outer core portion 33.

The retaining portions 75 each have a configuration similar to that of the retaining portion 45 of the holding member 4. In other words, the retaining portions 75 prevent the outer mold portion 8 (FIG. 7) covering the outer circumference of the outer core portion 33 from being separated from the core mold portion 7.

The core mold portion 7 is made of, for example, the thermoplastic resin or the thermosetting resin described in the item of the holding member 4. The core mold portion 7 may also contain a ceramic filler.

Unlike the present example, the outer core portions 33 may also be held by the holding member 4.

Others

The reactor 1 shown in FIGS. 1 and 2 may also include an outer mold portions 8 (see FIG. 7) that each cover at least a part of the outer circumference of the assembly 10. The outer mold portions 8 firmly integrate the components of the assembly 10. The outer mold portions 8 may cover the entire outer circumference of the assembly 10, or may also cover a portion of the outer circumference of the assembly 10 excluding the coil 2. In the latter configuration, because the coil 2 is exposed to the outside, heat dissipation of the reactor 1 is enhanced. In addition, the outer core portions 33 and 34 are protected from the external environment by the outer mold portions 8.

### Effects

According to the reactor 1 disclosed in the present example, even when the axial directions of the winding portions 21 and 22 are arranged along a horizontal plane, the outer core portion 34 is unlikely to come loose from the holding member 4. This is because the pressing portions 51 provided in the holding member 4 press the first outer circumferential surface 3c, which is the upper surface of the outer core portion 34, so that the outer core portion 34 is firmly held in the core accommodating portion 40.

Method for Manufacturing Reactor

An example of a method for manufacturing the reactor 1 according to the first embodiment will be described with reference to FIG. 7.

As shown in the upper diagram of FIG. 7, in the manufacturing method of the present example, the outer core portion 33 covered by the core mold portion 7 and the coil 2 are stacked in order from the vertically lower side. Next, the inner core portions 31 and 32 (FIGS. 1 and 2) are inserted into the winding portions 21 and 22 of the coil 2, and the holding member 4 is stacked on the end portions of the winding portions 21 and 22. Finally, the outer core portion 34 is fitted into the core accommodating portion 40 of the holding member 4 from above. According to such a manufacturing method of the present example in which the members are sequentially stacked from the vertically lower side, the assembly 10 of the reactor 1 can be easily manufactured.

Next, as shown in the lower diagram of FIG. 7, the assembly 10 is placed horizontally. Specifically, the assembly 10 is arranged so that the axial direction of the winding portion 21 extends along a horizontal plane. At this time, the outer core portion 34 is held by the holding member 4 using the pressing portions 51, and the outer core portion 34 does not come loose from the holding member 4. In this state, the outer mold portions 8 are formed on the outer circumferences of the outer core portions 33 and 34. As a result, the outer core portion 33 is integrated with the core mold portion 7 by the outer mold portion 8, and the outer core portion 34 is integrated with the holding member 4 by the outer mold portion 8. The outer mold portion 8 covering the outer core portion 33 and the outer mold portion 8 covering the outer core portion 34 are connected to each other inside the winding portions 21 and 22.

### Second Embodiment

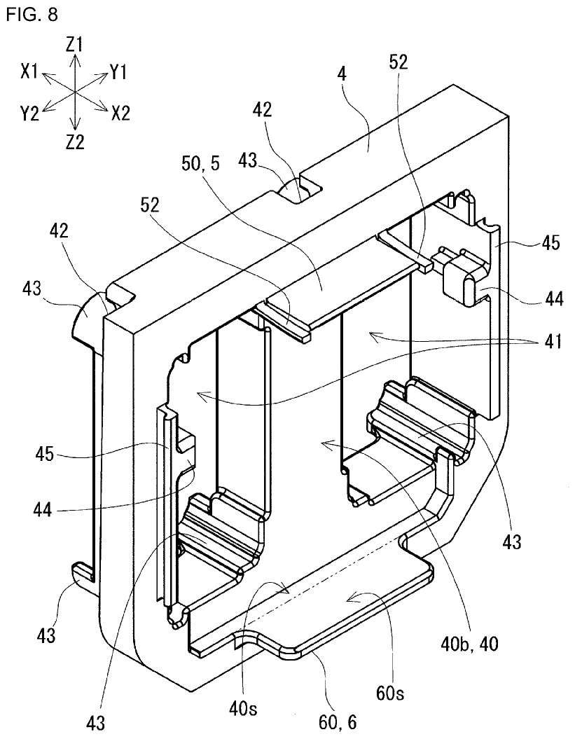

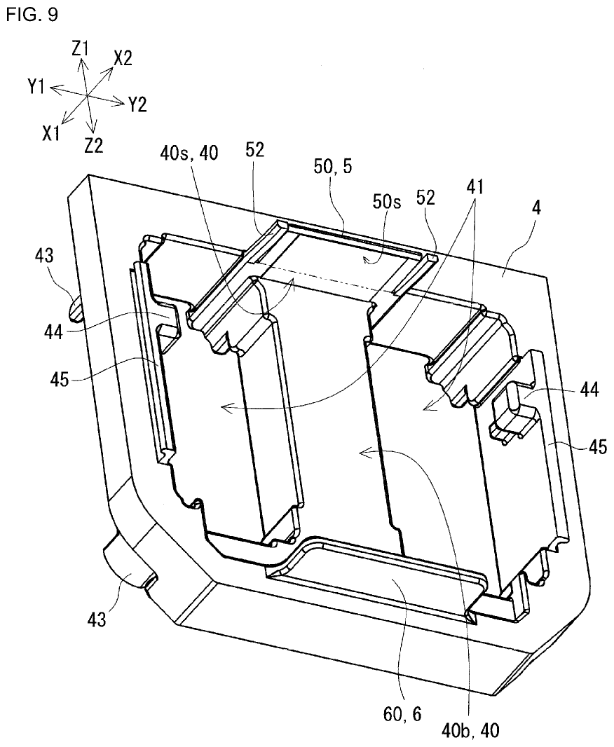

A reactor 1 according to a second embodiment will be described with reference to FIGS. 8 and 9. The reactor 1 according to the present example differs from the reactor 1 according to the first embodiment only in the configuration of the holding member 4. Accordingly, only the holding member 4 will be described in the present example.

As shown in FIGS. 8 and 9, the first holding portion 5 of the holding member 4 according to the present example includes two pressing portions 52 provided at positions at which they sandwich the plate-shaped piece 50. The pressing portions 52 according to the present example each have a cantilever spring shape. As shown in FIG. 9, the base ends of the pressing portions 52 are connected to the inner wall surface 40s of the core accommodating portion 40. The distal ends of the pressing portions 52 extend toward the X2 direction.

The pressing portions 52 formed by cantilever springs bend in a direction away from the first outer circumferential surface 3c of the outer core portion 34 (FIG. 2) when the outer core portion 34 is fitted into the core accommodating portion 40. Accordingly, the pressing portions 52 formed by cantilever springs are unlikely to damage the first outer circumferential surface 3c of the outer core portion 34. Furthermore, the pressing portions 52 formed by cantilever springs press the first outer circumferential surface 3c of the outer core portion 34 using the elasticity thereof, and firmly hold the outer core portion 34 in the core accommodating portion 40.

The pressing portions 52 formed by cantilever springs provided on the respective sides of the plate-shaped piece 50 are independent from the plate-shaped piece 50. The pressing portions 52 formed by cantilever springs and independent from the plate-shaped piece 50 are more easily formed than the pressing portions formed by cantilever springs and integrally provided on the first surface 50s of the plate-shaped piece 50.

The inner wall surface 40s of the core accommodating portion 40 has higher rigidity and is less likely to deform than the plate-shaped piece 50. Accordingly, if the base ends of the pressing portions 52 formed by cantilever springs are connected to the inner wall surface 40s of the core accommodating portion 40, the pressing force applied by the pressing portions 52 formed by cantilever springs can be appropriately maintained. Unlike the present example, if the base ends of the pressing portions 52 formed by cantilever springs are connected to the plate-shaped piece 50, the plate-shaped piece 50 may also be deformed in accordance with the bending of the pressing portions 52 formed by cantilever springs, and the pressing force applied by the pressing portions 52 may not be stable.

As the pressing portions 52 formed by cantilever springs different from the present example, pressing portions 52 whose distal ends extend toward the X1 direction may be used. In this case, the base ends of the pressing portions 52 are provided on the first surface 50s of the plate-shaped piece 50. The number of pressing portions 52 may be one, or three or more.

### Third Embodiment

Converter and Power Conversion Device

The reactor 1 according to the first and second embodiments can be used for applications that satisfy the following electric-conduction conditions. As the electric-conduction conditions, for example, the maximum direct current is about 100 A or more and 1000 A or less, the average voltage is about 100 V or more and 1000 V or less, and the frequency is about 5 kHz or more and 100 kHz or less. The reactor 1 according to the first and second embodiments can be representatively used as a component of a converter mounted on a vehicle such as an electric vehicle or a hybrid vehicle, or a component of a power conversion device including a converter.

As shown in FIG. 10, a vehicle 1200 such as a hybrid vehicle or an electric vehicle includes a main battery 1210, a power conversion device 1100 connected to the main battery 1210, and a motor 1220 driven by electric power supplied from the main battery 1210 and used for travel by the vehicle. The motor 1220 is representatively a three-phase AC motor, drives wheels 1250 when the vehicle is traveling, and functions as a generator when electric power is being regenerated. When the vehicle 1200 is a hybrid vehicle, the vehicle 1200 includes an engine 1300 in addition to the motor 1220. In FIG. 10, an inlet is illustrated as a charging point of the vehicle 1200, but the vehicle 1200 may also include a plug serving as the charging point.

The power conversion device 1100 includes a converter 1110 connected to the main battery 1210, and an inverter 1120 that is connected to the converter 1110 and performs mutual conversion between DC and AC. The converter 1110 shown in the present example boosts the input voltage of the main battery 1210 that is about 200 V to about 300 V to about 400 V to 700 V, and supplies the boosted voltage to the inverters 1120 when the vehicle 1200 travels. At the time of regeneration of electric power, the converter 1110 steps down an input voltage output from the motor 1220 via the inverter 1120 to a DC voltage suitable for the main battery 1210, and charges the main battery 1210. The input voltage is a DC voltage. The inverter 1120 converts the direct current boosted by the converter 1110 into a predetermined alternating current and supplies the alternating current to the motor 1220 during travel by the vehicle 1200, and converts an alternating current output from the motor 1220 into a direct current and outputs the direct current to the converter 1110 during regeneration of electric power.

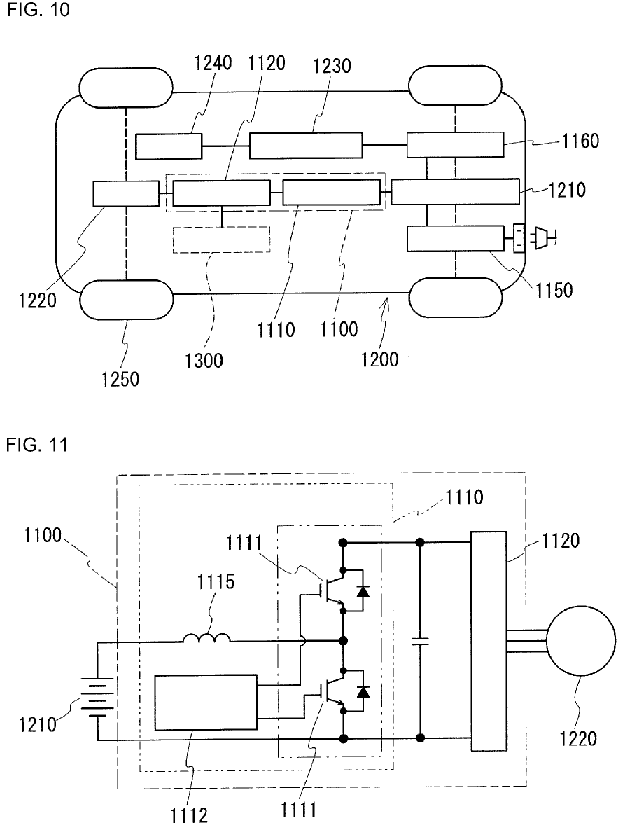

As shown in FIG. 11, the converter 1110 includes a plurality of switching elements 1111, a drive circuit 1112 that controls the operation of the switching elements 1111, and a reactor 1115, and converts an input voltage by repeatedly turning ON/OFF the switching elements 1111. Here, the conversion of the input voltage is to step up or down the input voltage. Power devices such as field effect transistors or insulated gate bipolar transistors are used as switching elements 1111. The reactor 1115 has a function of smoothing a change in a current when the current increases or decreases in response to a switching operation by using properties of a coil that prevents a change in a current flowing through a circuit. The reactor 1115 includes the reactor 1 according to any one of the first and second embodiments. By including the reactor 1 in which the outer core portion 34 is firmly held by the holding member 4, the power conversion device 1100 and the converter 1110 have excellent productivity.

In addition to the converter 1110, the vehicle 1200 includes a power supply device converter 1150 connected to the main battery 1210, and an auxiliary machine power supply converter 1160 that is connected to the main battery 1210 and a sub-battery 1230 serving as a power source of the auxiliary machines 1240 and converts a high voltage of the main battery 1210 into a low voltage. The converter 1110 representatively performs DC-DC conversion, while the power supply device converter 1150 and the auxiliary machine power supply converter 1160 perform AC-DC conversion. Note that the power supply device converter 1150 may perform DC-DC conversion. As the reactor of the power supply device converter 1150 or the auxiliary machine power supply converter 1160, a reactor having a configuration similar to that of the reactor 1 according to the first or second embodiment and appropriately changed in size, shape, or the like can be used. In addition, the reactor 1 according to any one of the first and second embodiments can be used in a converter that converts input power and only steps up or only steps down the input power.

1. A reactor comprising:
an assembly in which a coil, a magnetic core, and a holding member are combined,
wherein the coil includes a winding portion formed by winding a wire,
the magnetic core includes an inner core portion disposed inside the winding portion and an outer core portion disposed outside the winding portion,
the holding member is disposed between an end surface of the winding portion and the outer core portion,
the holding member includes:
an outer surface facing a side on which the outer core portion is disposed;
a recessed core accommodating portion into which a part of the outer core portion is fitted; and
a first holding portion facing a first outer circumferential surface of the outer core portion,
the first holding portion includes:
a plate-shaped piece extending from the outer surface to the first outer circumferential surface; and
a pressing portion that presses the first outer circumferential surface,
the plate-shaped piece has a first surface flush with an inner wall surface of the core accommodating portion, and
the pressing portion protrudes toward the first outer circumferential surface relative to the first surface.

2. The reactor according to claim 1, wherein the pressing portion is a protrusion provided on the first surface, and
the protrusion extends in a depth direction of the core accommodating portion.

3. The reactor according to claim 2, wherein a protrusion amount of the protrusion from the first surface increases toward a bottom surface of the core accommodating portion.

4. The reactor according to claim 2, wherein a cross-sectional shape orthogonal to an extending direction of the protrusion is a tapered shape that narrows in a protruding direction of the protrusion.

5. The reactor according to claim 1, wherein the pressing portion is a cantilever spring.

6. The reactor according to claim 5, wherein the cantilever spring is provided on a side of the plate-shaped piece.

7. The reactor according to claim 5, wherein the base end of the cantilever spring is connected to the inner wall surface of the core accommodating portion.

8. The reactor according to claim 1, wherein the holding member includes a through hole penetrating the inner core portion, and
in a front view of the holding member as seen from the outer surface side, the pressing portion is provided at a position overlapping the through hole.

9. The reactor according to claim 1, wherein the holding member includes a second holding portion extending from the outer surface in an axial direction of the winding portion, and
the second holding portion is provided at a position facing the first holding portion with the core accommodating portion interposed therebetween.

10. The reactor according to claim 1, further comprising:
an outer mold portion that covers at least a part of an outer circumference of the assembly.

11. A converter comprising the reactor according to claim 1.

12. A power conversion device comprising the converter according to claim 11.
